(19) United States
(12) Patent Application Publication
(10) Pub. No.: US 2003/0174093 A1
(43) Pub. Date: Sep. 18, 2003

(54) Antenna arrangement on a mobile communication terminal, in particular a mobile telephone

(76) Inventors: Stefan Huber, Munchen (DE); Martin Oelschlager, Berlin (DE); Michael Schreiber, Aying-Goggenhofen (DE); Martin Weinberger, Munchen (DE)

Correspondence Address: BELL, BOYD & LLOYD, LLC, P. O. BOX 1135, CHICAGO, IL, 60690-1135, US

(21) Appl. No.: 10/344,395

(22) PCT Filed: Jul. 31, 2001
(86) PCT No.: PCT/DE01/02906

(30) Foreign Application Priority Data
Aug. 11, 2000 (DE) 100 39 427.2

(51) Int. Cl. H01Q 1/24

(52) U.S. Cl. 343/702; 343/895

(57) ABSTRACT

The invention relates to an antenna arrangement on a mobile communication terminal, in particular on a mobile telephone, comprising an appliance housing and, within said appliance housing, electronic components and metallic parts arranged on a communication terminal board (1) as well as a mass surface. The antenna arrangement has an irradiating element (5), arranged within the appliance housing, comprising a structure and, between the irradiating element (5) and the communication terminal board (1) are means to protect the irradiating element (5) against disturbances caused by the electronic components or metallic parts, which are connected to the mass surface of the communication terminal board (1).

Antenna arrangement for a mobile communications terminal, in particular a mobile telephone.

The invention relates to an antenna arrangement for a mobile communications terminal, in particular a mobile telephone, as claimed in the precharacterizing clause of patent claim 1.

The first mobile telephones (cellular phones) were originally designed only for one of the corresponding mobile radio systems, that is to say for one transmission/reception band. With the progress in the development of mobile radio technology, such as utilization of the networks, roaming at home and abroad, there has been an increasing requirement for terminals which can be used in different mobile radio networks. It was therefore necessary to design mobile radio terminals for two or even three transmission/reception bands, and corresponding antennas had to be developed.

A dual-band hybrid antenna is known from DE 197 58 217 A1. An antenna such as this is produced by the configuration of a miniaturized antenna component extended over an area. This antenna component has the characteristic that it produces a vertically polarized omnidirectional radiation characteristic in the azimuth plane within the GSM or DCS frequency bands between 890 MHz and 960 MHz, as well as between 1710 MHz and 1880 MHz. A dual-band hybrid antenna such as this is used (inter alia) for mobile radio terminals. In this case, the planar radiating element forms an antenna component only for external insulation or external applications, not only for land vehicles and aircraft but also for maritime moving vehicles.

For portable communications appliances, such as mobile telephones, there is a development trend toward ever smaller, particularly convenient appliances, which have small dimensions and a reduced mass. With regard to the shape of the appliances, there has increasingly been a new trend for the antenna to be located within the appliance housing and not, as in the past, to be in the form of a stud antenna or telescopic antenna on the appliance housing. The antenna is, for example, fitted behind the earpiece or other components which are arranged on the front face of the mobile radio terminal. In the past, this problem has been solved by using a PIFA antenna. However, less and less space is available for an integrable antenna such as this, and this would lead to an adverse effect on the performance of antennas of this type. However, a small PIFA antenna in the form of a dual-band or multiband antenna has too narrow a bandwidth for use in the mobile radio field.

Furthermore, in the past, F antennas, inverted F antennas, patch antennas, microstrip antennas and two-sided PCB (Printed Circuit Board) antennas have been known, which cover a number of frequency bands, but which either occupy too much space or in which the capability to tune them for multiband use involves problems.

Furthermore, spiral antenna elements are known for the antennas of telecommunications apparatuses, but these require a large amount of space for integration in the appliance housing and they are slightly mistuned by adjacent components, for example the earpiece.

A further problem with integrated antennas as mobile radio terminals become ever smaller is that the distance between the antenna and the head is becoming less, thus increasing the specific absorption rate of radio-frequency energy in the area of the user's head (so-called SAR value). In some circumstances, this is disadvantageous for the user, due to the pulsed radio-frequency waves in the transmission mode.

An integrable antenna arrangement for mobile telecommunications terminals is known from DE 198 24 145, in which metallic components of a battery which is required in any case, or of a rechargeable battery, are used as a resonator or resonator surface of a planar radiating element, and a further metallic surface which is separated from this by a dielectric and is provided in the appliance housing forms a radiating element base surface for a planar antenna. The resonant frequency of the radiating element can be adjusted within certain limits by the choice of the dielectric constants of the battery compartment cover of the corresponding section of the housing and, possibly, by using an additional dielectric. However, the antenna parameters are disadvantageously critically governed by the geometry and the material of the battery or of the rechargeable battery. This antenna arrangement cannot cover a number of frequency bands.

The object of the present invention is thus to provide an antenna arrangement which can be designed flexibly for efficient operation in a number of frequency bands, with disturbances being reduced by means of appliance parts which occupy only a small amount of space, can be arranged within the appliance housing, and can be produced at low cost.

This object is achieved by an antenna arrangement having the features of patent claim 1.

The invention encompasses the fundamental idea of providing an antenna arrangement which can be integrated in a mobile communications terminal and which, apart from a structured radiating element, has means for desensitizing the radiating element against disturbance influences which originate from metal parts and electronic components of the appliance. One preferred embodiment also encompasses the idea of using a mirror as the densensitization means, which is connected to the chassis of the communications terminal and whose size is similar to that of the radiating element. Finally, the invention encompasses the idea of designing the mirror such that it and the radiating element have resonance points at the same frequencies.

The influence of disturbances on the antenna characteristics is considerably reduced by fitting the mirror essentially between the radiating element and the appliance electronics or audio components and, in particular, the earpiece.

The mirror and the radiating element are preferably located on the lower face of the communications terminal board, in order to provide particularly good suppression for disturbances caused by components located on the front face.

The distance between the mirror and the radiating element can preferably be varied in order to adjust the emission characteristics. The distance between the mirror and the communications terminal board is preferably 1 to 2 mm, and the distance between the radiating element and the mirror is preferably 3 to 6 mm.

For mechanical reasons and in order to improve the emission characteristics or for optimum utilization of an available volume, it is likewise possible to incorporate dielectric or magnetic materials in the antenna arrangement, which can partially or else completely fill the entire antenna structure. Combinations of different dielectric and/or magnetic substances as well as air are also possible. The distance between the mirror and the radiating element can be reduced by using a dielectric, for example a ceramic plate, with the mirror being arranged, for example, on the lower face of the ceramic plate and the radiating element being arranged on its upper face.

In the case of multiband antennas, it is advantageous for the mirror to essentially have the same structure as the radiating element since it can then be adjusted more easily to the same resonant frequencies as the radiating element.

The radiating element and the mirror structure in one specific embodiment have the structure of a meandering shape, with these structures being arranged parallel to one another and extending essentially parallel to the plane of the terminal board. The two structures may, however, also have an essentially planar spiral shape.

In one preferred embodiment, the radiating element is in the form of a PCB (Printed Circuit Board) antenna. In this embodiment, it comprises a conductive track which is arranged on a printed circuit board. The mirror may be configured in an analogous manner.

The radiating element and the mirror are preferably connected to the side of the communications terminal board facing them by means of contact elements which are resistant to vibration, oscillations and impacts. Bending springs are preferably used as the contact elements. The bending springs preferably each make contact with the end of the radiating element and of the mirror, in order to minimize effects on the radiation characteristics of the antenna arrangement. The flexibility of the bending springs allows slight adjustment of the distance, if required, between the radiating element and the mirror that is arranged parallel to it, and hence makes it possible to produce a capacitively tunable antenna structure.

In the case of one embodiment that is preferred for multiband terminals, two or more mirrors are provided, which lie directly on the communications terminal board and may have different structures, for example being in the form of a strip for a first band and having a meandering shape for a second band.

The proposed antenna arrangement may be used in mobile radio terminals which operate in the future UMTS frequency bands between 1920 MHz and 2170 MHz. Use in combined mobile radio/GPS appliances is advantageously also possible.

Advantages and useful forms of the invention can also be found in the dependent claims and in the following description of preferred exemplary embodiments with reference to the figures, in which:

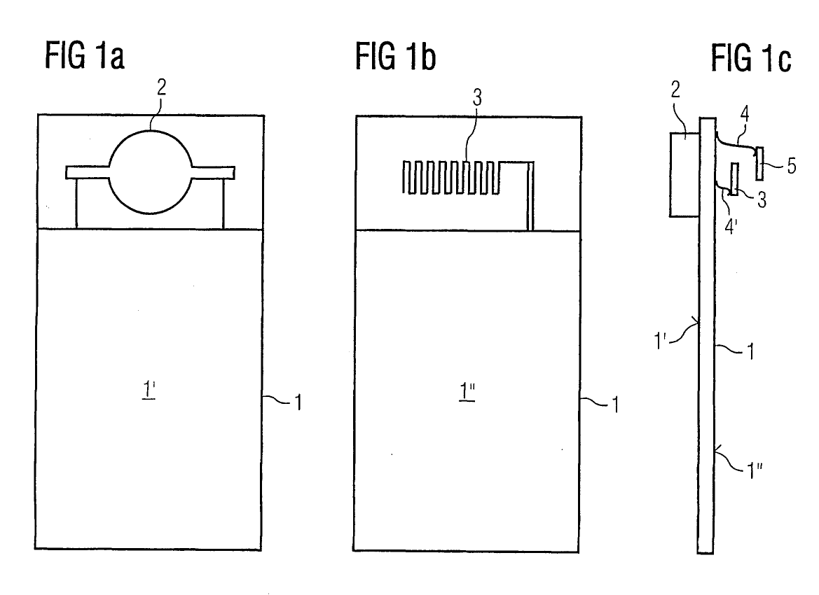

FIGS. 1a, 1b and 1c each show a schematic illustration of a mobile telephone board with the antenna arrangement according to the invention, in the form of a plan view of the upper face and lower face of the mobile telephone board, and a side view,

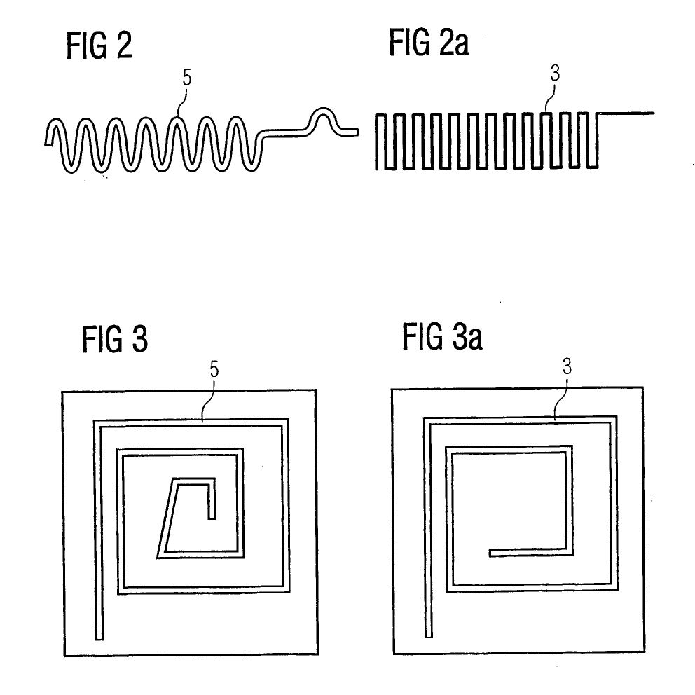

FIGS. 2 and 2a show one embodiment of the radiating element, and the corresponding mirror structure,

FIGS. 3 and 3a show a further embodiment of the radiating element, and the corresponding mirror structure,

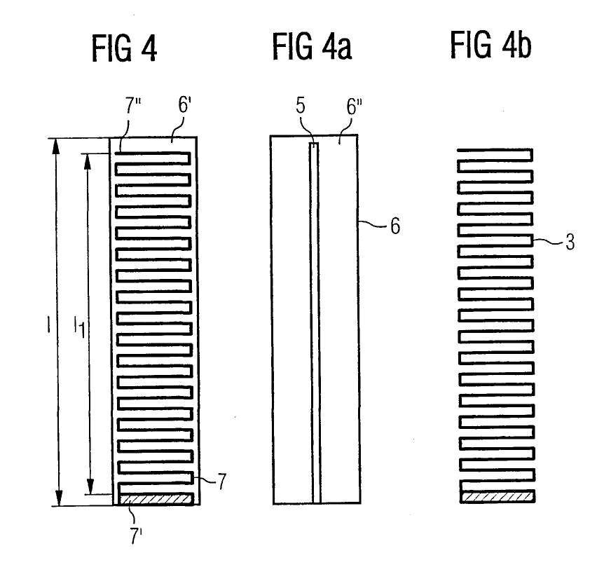

FIGS. 4, 4a and 4b show a further embodiment of the radiating element, and the corresponding mirror structure, and

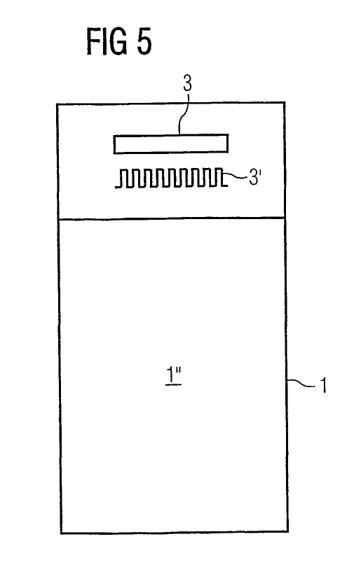

FIG. 5 shows a schematic illustration of a mobile telephone board, in the form of a plan view.

FIG. 1a shows a simplified schematic plan view of the upper face 1′ of a mobile telephone board 1 with an earpiece 2 arranged on the upper part of the mobile telephone board (main board) 1.

FIG. 1b shows a simplified schematic view of the lower face 1″ of the mobile telephone board 1, on whose upper part a mirror structure 3 is arranged by means of a contact spring 4. The mirror structure has a meandering shape, which is arranged parallel to the plane of the mobile telephone board 1.

FIG. 1c is a highly simplified side view of the mobile telephone board 1 with a radiating element 5 which is connected to the mobile telephone board 1 by means of a contact spring 4′. The radiating element 5 is arranged at a predetermined distance from the mirror structure 3, which is located between the radiating element 5 and the mobile telephone board 1, in order to eliminate disturbance influences from the (largely metallic) earpiece 2 on the radiating element 5.

The distance between the mirror structure 3 and the radiating element 5 is governed by the length of the contact springs 4 and 4′, and is thus variable. The tuning state can be varied by varying the distance between the two components or by incorporating dielectric materials into the antenna structure. The mirror structure 3 is connected by means of the contact spring 4′ to the ground surface of the communications terminal board 1 in order to form an electrical contact. The radiating element 5 is itself connected to the board 1 by means of the contact spring 4.

FIGS. 2 and 2a show preferred embodiments of the mirror structure 3 and of the radiating element 5, with the mirror structure 3 being in the form of a meander, and the radiating element 5 having a similar zigzag shape. In order to achieve optimum disturbance suppression, the mirror structure 3 is of a similar size to the radiating element 5.

FIGS. 3 and 3a show a further embodiment of the antenna arrangement according to the invention, with the radiating element 5 having an essentially planar spiral shape, and the mirror structure 3 having a similar spiral shape. The spiral shape of the radiating element 5 is in this case defined by a conductor run, which tapers inward with a number of bends. The mirror structure 3 has a similar shape, with the spiral not being developed so far inward as in the case of the radiating element.

FIGS. 4, 4a and 4b show a further embodiment of the antenna arrangement according to the invention. In this embodiment, the radiating element is a PCB antenna. The PCB antenna has a printed circuit board 6, which has a front face 6′, a rear face 6″ and a fixed length 1. A conductive track 7 is arranged on the front face 6′ of the printed circuit board 6. The conductive track 7 has a physical length 11 from a first end 7′ to a second end 7″, with the length l₁ of the conductive track corresponding approximately to the length l of the printed circuit board. The rear face is fitted with a linear conductor 5. The mirror structure 3 has a structure corresponding to the PCB antenna, as is shown in FIG. 4b.

FIG. 5 shows a schematic lower view 1b of a further embodiment of the mobile telephone board 1, on whose upper part two mirrors 3 and 3′ rest directly. The mirror 3 has a structure in the form of a rod for a first band, and the second mirror 3′ has a meandering structure for a second band. The two structures are located side by side on the board 1, to be precise between the earpiece and the radiating element. The antenna arrangement according to the invention is not restricted to these exemplary embodiments. In order to optimize the desired response of the antenna arrangement, additional elements, such as conductor lengths, discrete components or printed elements, can be inserted into the supply line to the mirror structure. This allows the antenna characteristics to be optimized. The mirror structure may also, for example, be produced in an intermediate layer in a PCB structure.

1. An antenna arrangement for a mobile communications terminal, in particular a mobile telephone, which has an appliance housing and, within the appliance housing, electronic components (which are arranged on a communications terminal board (1)) and metallic parts as well as a ground surface, with the antenna arrangement having a radiating element (5) which is arranged within the appliance housing,
characterized in that
the radiating element (5) has a structure and, between the radiating element (5) and the communications terminal board (1), a mirror (3) having a mirror structure are provided for desensitizing the radiating element (5), with regard to the antenna characteristics, against disturbance influences from the electronic components or metallic parts, which mirror is connected to the ground surface of the communications terminal board (1).

2. The antenna arrangement as claimed in claim 1,
characterized in that
the mirror (3) has a metallic surface or structure dimensioned such that it provides shielding against any disturbance influence resulting from inductive, capacitive or radiating coupling from the electronic components or metallic parts.

3. The antenna arrangement as claimed in claim 1 or 2,
characterized by
the mirror (3) being designed such that it has resonances at the same frequencies as the radiating element (5).

4. The antenna arrangement as claimed in one of the preceding claims,
characterized in that
the radiating element (5) and the mirror (3) are located on the lower face (1″) of the communications terminal board (1), with the distance between the mirror (3) and the radiating element (5) being variable in order to adjust the emission characteristics.

5. The antenna arrangement as claimed in one of the preceding claims,
characterized in that
a dielectric, in particular a ceramic plate, is provided in order to reduce the distance between the mirror (3) and the radiating element (5), with the mirror (3) in particular being printed onto a lower face of the ceramic plate, and the radiating element (5) being printed onto an upper face of the ceramic plate.

6. The antenna arrangement as claimed in one of the preceding claims,
characterized in that
the distance between the mirror (3) and the communications terminal board (1) is 1 to 2 mm, and the distance between the radiating element (5) and the mirror (3) is 3 to 6 mm.

7. The antenna arrangement as claimed in one of the preceding claims,
characterized in that
the mirror (3) has a structure which, in particular, is similar to that of the radiating element (5).

8. The antenna arrangement as claimed in one of the preceding claims,
characterized in that
the mirror (3) and/or the radiating element (5) have/has an essentially planar zigzag or meandering shape and extend/extends essentially parallel to the plane of the communications terminal board (1).

9. The antenna arrangement as claimed in one of claims 1 to 7,
characterized in that
the mirror (3) and the radiating element (5) have an essentially planar spiral shape, and extend essentially parallel to the plane of the communications terminal board (1).

10. The antenna arrangement as claimed in one of claims 2 to 9,
characterized in that
two or more mirrors (3, 3′) are provided and, in particular, are arranged alongside one another on the communications terminal board (1).

11. The antenna arrangement as claimed in one of the preceding claims,
characterized in that
the mirror or mirrors (3, 3′) and the radiating element (5) are connected to the communications terminal board (1) by means of contact elements,
in particular contact springs (4, 4′), which are resistant to vibration, oscillations and impacts.

12. The antenna arrangement as claimed in one of the preceding claims,
characterized by
a holding apparatus, in which the mirror or mirrors (3, 3′) and the radiating element (5) are fitted in a fixed position relative to one another.

13. The antenna arrangement as claimed in one of the preceding claims,
characterized in that
the radiating element (5) and/or the mirror or the mirrors (3, 3′) are PCB elements.

14. The antenna arrangement as claimed in one of claims 2 to 13,
characterized in that
elements, in particular conductor lengths and/or discrete components, are inserted into a supply line to the mirror, in order to optimize the antenna characteristics.
